(19) United States
(12) Patent Application Publication
(10) Pub. No.: US 2009/0091498 A1
(43) Pub. Date: Apr. 9, 2009

(54) Dual polarization antenna device for creating a dual band function

(76) Inventors: Chih-Ming Chen, Neipu Township (TW); Min-Sheng Ma, Jhunan Township (TW); Yuch-Pi Huang, Jhunan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,991

(22) Filed: Oct. 9, 2007

(51) Int. Cl. H01Q 9/04; H01Q 1/38

(52) U.S. Cl. 343/700 MS

(57) ABSTRACT

A dual polarization antenna device for creating a dual band function, includes: a first dielectric body, a patch layer, a first phase difference changing structure, a second dielectric body, a common metal layer, a ground layer, a second phase difference changing structure, a first antenna feed pin, and a second antenna feed pin. The first dielectric body, the patch layer, the first phase difference changing structure, the common metal layer, and the first antenna feed pin are combined together to form an upper polarization antenna structure. The second dielectric body, the common metal layer, the second phase difference changing structure, and the ground layer are combined together to form a lower polarization antenna structure. Therefore, the upper polarization antenna structure and the lower polarization antenna structure are combined to create both the dual polarization and the dual band functions.

### BACKGROUND OF THE INVENTION

1. Field of the Invention

The present invention relates to an antenna device, and particularly relates to a dual polarization antenna device for creating a dual band function.

2. Description of the Related Art

Due to the development of communication technology, a lot of electronic products have been developed that use wireless communication technology, such as cell phones, wireless Internet devices, and personal digital assistants (PDAs), etc. The requirements demanded by the wireless communication devices from consumers has become higher and higher, namely in terms of the appearance and the dimensions of the devices. For cell phones, the receiving frequency has developed from a single frequency, to two, then three, and now four frequencies. Consumers also prefer cell phones which have a fresh appearance, small dimensions, a light weight, and are portable.

Moreover, an antenna with dual polarization and dual band functions is disclosed due to the progress of communication technology. Dual band function means that the antenna can be used in two different bands. The antenna will generate peak points of gain in the two different bands, and the antenna's impedance is matched.

### SUMMARY OF THE INVENTION

One particular aspect of the present invention is to provide a dual polarization antenna device for creating a dual band function. The present invention provides two types of dual polarization structures and the two dual polarization structures share a common metal layer to create both the dual polarization and the dual band functions for user to use.

In order to achieve the above-mentioned aspects, the first embodiment of the present invention provides a dual polarization antenna device for creating a dual band function, comprising: a first dielectric body, a patch layer, a first phase difference changing structure, a second dielectric body, a common metal layer, a ground layer, a second phase difference changing structure, a first antenna feed pin, and a second antenna feed pin.

Moreover, the patch layer is formed on a top surface of the first dielectric body. The first phase difference changing structure is formed on the patch layer. The common metal layer is formed between the first dielectric body and the second dielectric body. The ground layer is formed on a bottom surface of the second dielectric body. The second phase difference changing structure is formed in an inner portion and on the bottom surface of the second dielectric body. The first antenna feed pin penetrates the first dielectric body and the second dielectric body in sequence. The second antenna feed pin penetrates the second dielectric body.

Therefore, the first dielectric body, the patch layer, the first phase difference changing structure, the common metal layer, and the first antenna feed pin are combined together to form an upper polarization antenna structure. The second dielectric body, the common metal layer, the second phase difference changing structure, and the ground layer are combined together to form a lower polarization antenna structure.

In order to achieve the above-mentioned aspects, the second embodiment of the present invention provides a dual polarization antenna device for creating a dual band function. The difference between the second embodiment and the first embodiment is that the second embodiment lacks a first phase difference changing structure. Hence, the first dielectric body, the patch layer, the common metal layer, and the first antenna feed pin are combined together to form an upper polarization antenna structure.

In order to achieve the above-mentioned aspects, the third embodiment of the present invention provides a dual polarization antenna device for creating a dual band function. The difference between the third embodiment and the first embodiment is that a second phase difference changing structure is formed on a common metal layer.

In order to achieve the above-mentioned aspects, the fourth embodiment of the present invention provides a dual polarization antenna device for creating a dual band function. The difference between the fourth embodiment and the first embodiment is that the fourth embodiment lacks a first phase difference changing structure and a second phase difference changing structure. Hence, the first dielectric body, the patch layer, the common metal layer, and the first antenna feed pin are combined together to form an upper polarization antenna structure. The second dielectric body, the common metal layer, the ground layer, and the second antenna feed pin are combined together to form a lower polarization antenna structure.

In conclusion, the upper polarization antenna structure and the lower polarization antenna structure are combined to create both the dual polarization and the dual band functions.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is top view of the first part according to the first embodiment of the present invention;

FIG. 2 is a side, cross-sectional view of the first part according to the first embodiment of the present invention;

FIG. 3 is top view of the second part according to the first embodiment of the present invention;

FIG. 4 is a side, cross-sectional view of the second part according to the first embodiment of the present invention;

FIG. 5 is bottom view of the second part according to the first embodiment of the present invention;

FIG. 6 is a side, cross-sectional view of a combination of the first part and the second part according to the first embodiment of the present invention;

FIG. 7 is a bottom view of a combination of the first part and the second part according to the first embodiment of the present invention;

FIG. 8 is top view of the first part according to the second embodiment of the present invention;

FIG. 9 is a side, cross-sectional view of the first part according to the second embodiment of the present invention;

FIG. 10 is top view of the second part according to the second embodiment of the present invention;

FIG. 11 is a side, cross-sectional view of the second part according to the second embodiment of the present invention;

FIG. 12 is bottom view of the second part according to the second embodiment of the present invention;

FIG. 13 is a side, cross-sectional view of a combination of the first part and the second part according to the second embodiment of the present invention;

FIG. 14 is a bottom view of a combination of the first part and the second part according to the second embodiment of the present invention;

FIG. 15 is top view of the second part according to the third embodiment of the present invention;

FIG. 16 is a side, cross-sectional view of the second part according to the third embodiment of the present invention;

FIG. 17 is a side, cross-sectional view of a combination of the first part of the first embodiment and the second part of the third embodiment;

FIG. 18 is top view of the second part according to the fourth embodiment of the present invention;

FIG. 19 is a side, cross-sectional view of the second part according to the fourth embodiment of the present invention; and

FIG. 20 is a side, cross-sectional view of a combination of the first part of the first embodiment and the second part of the fourth embodiment.

### DETAILED DESCRIPTION OF THE PREFERRED EMBODIMENTS

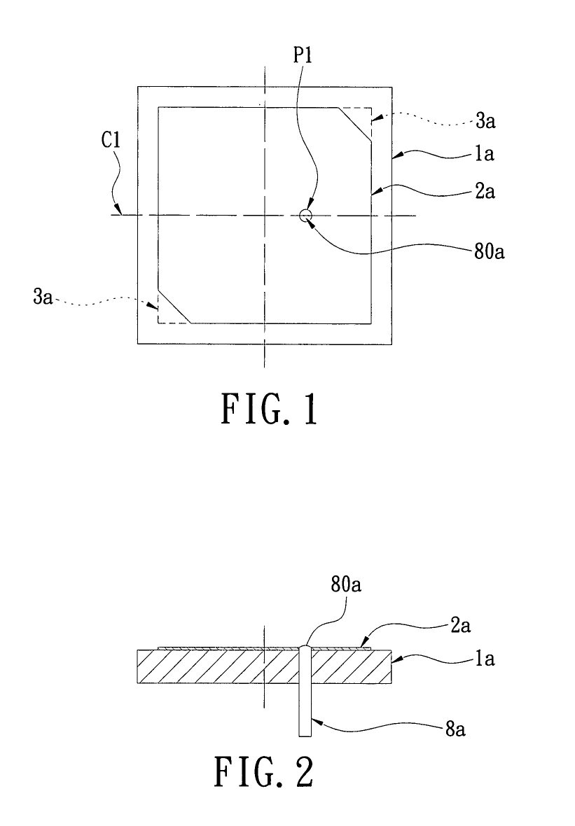

Referring to FIGS. 1 to 7, the first embodiment of the present invention provides a dual polarization antenna device for creating a dual band function, including: a first dielectric body 1a, a patch layer 2a, a first phase difference changing structure 3a, a second dielectric body 4a, a common metal layer 5a, a ground layer 6a, a second phase difference changing structure 7a, a first antenna feed pin 8a, and a second antenna feed pin 9a. The first phase difference changing structures 3a and the second phase difference changing structures 7a are 90 degree phase difference changing structures.

Referring to FIGS. 1 and 2 again, the first part of the first embodiment of the present invention is disclosed. The first dielectric body 1a is made of dielectric material, and the dielectric material can be a ceramic material or an insulative material, etc. The patch layer 2a is formed on a top surface of the first dielectric body 1a. The first phase difference changing structure 3a is formed on the patch layer 2a.

For the first embodiment, the first phase difference changing structure 3a is a pair of cutting areas that are formed on two diagonal edges of the patch layer 2a. The pair of cutting areas is a pair of triangular areas of the same size. In other words, the patch layer 2a has a square shape and is formed on the first dielectric body 1a. The pair of cutting areas on the two diagonal edges of the patch layer 2a need to be cut to generate the 90 degree phase difference. In addition, a top side of the first antenna feed pin 8a is exposed outside of the patch layer 2a to form a first feed point 80a. The first feed point 80a is disposed on a two opposite sides center line C1 of the patch layer 2a. A position P1 of the first feed point 80b is close to a center point of the two opposite sides center line C1 as FIG. 1.

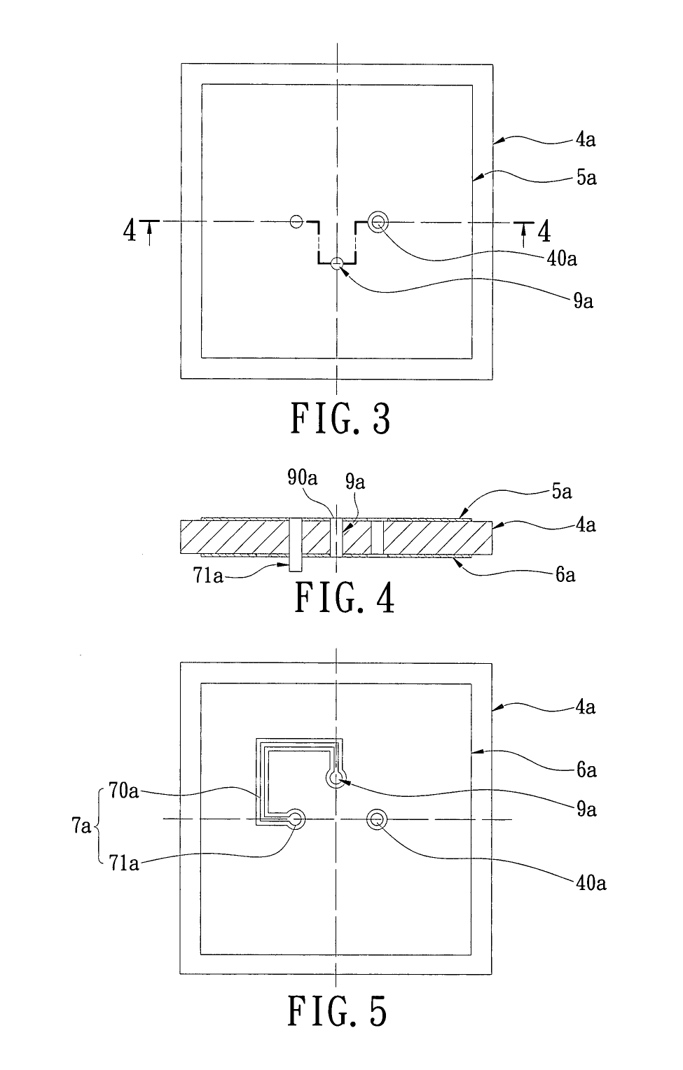

Referring to FIGS. 3 to 5 again, the second part of the first embodiment of the present invention is disclosed. The second dielectric body 4a is also made of dielectric material. The dielectric material can be a ceramic material or an insulative material, etc. The second dielectric body 4a has a through hole 40a corresponding to the first antenna feed pin 8a. The common metal layer 5a is formed on a top surface of the second dielectric body 4a. The ground layer 6a is formed on a bottom surface of the second dielectric body 4a.

The second phase difference changing structure 7a is formed in an inner portion and on the bottom surface of the second dielectric body 4a. The second phase difference changing structure 7a includes a metal leading wire 70a and an antenna pin 71a. The ground layer 6a has an exposed area for exposing the second dielectric body 4a. Hence, the metal leading wire 70a is formed in the exposed area and on the bottom surface of the second dielectric body 4a and is insulated from the ground layer 6a to form a coplanar waveguide. One side of the metal leading wire 70a is electrically connected with a bottom side of the second antenna feed pin 9a, while the other side of the metal leading wire 70a is electrically connected with the antenna pin 71a.

The antenna pin 71a penetrates the second dielectric body 4a. A top side of the antenna pin 71a is exposed outside of the common metal layer 5a. A bottom side of the antenna pin 71a extends from a bottom surface of ground layer 6a.

A top side of the second antenna feed pin 9a is exposed outside of the common metal layer 5a to form a second feed point 90a. A bottom side of the second antenna feed pin 9a is exposed outside of a bottom surface of the ground layer 6a.

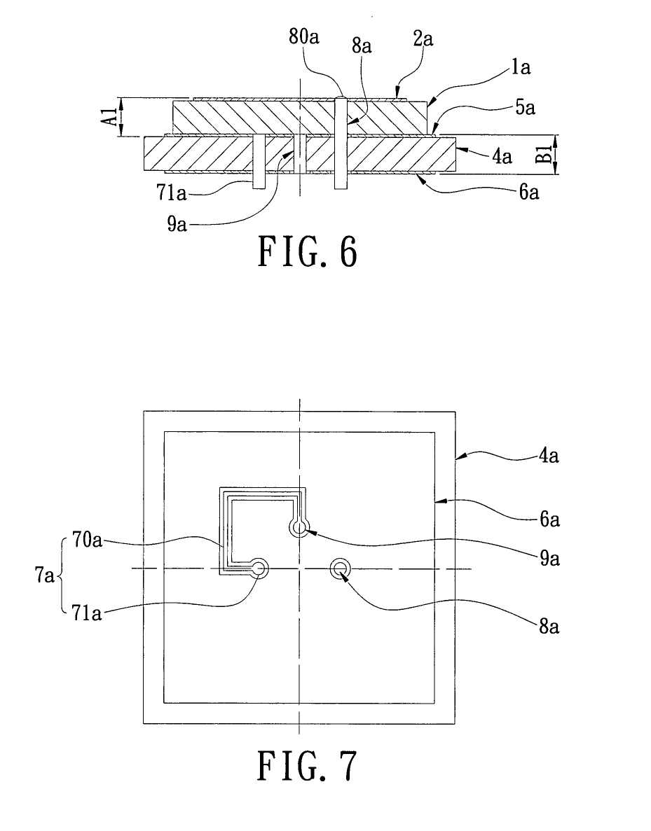

Referring to FIGS. 6 to 7 again, when the first part and the second part are combined together, the common metal layer 5a is formed between the first dielectric body 1a and the second dielectric body 4a. The first antenna feed pin 8a penetrates the first dielectric body 1a and the second dielectric body 4a in sequence. The bottom side of the first antenna feed pin 8a extends from the bottom surface of the ground layer 6a. The first antenna feed pin 8a is insulated from the common metal layer 5a and the ground layer 6a. The second antenna feed pin 9a penetrates the second dielectric body 4a, and the second antenna feed pin 9a is insulated from the ground layer 6a.

The first part and the second part share the common metal layer 5a. Hence, the first dielectric body 1a, the patch layer 2a, the first phase difference changing structure 3a, the common metal layer 5a, and the first antenna feed pin 8a are combined together to form an upper polarization antenna structure A1. The second dielectric body 4a, the common metal layer 5a, the second phase difference changing structure 7a, and the ground layer 6a are combined together to form a lower polarization antenna structure B1.

Therefore, the upper polarization antenna structure A1 and the lower polarization antenna structure B1 are combined to create both the dual polarization and the dual band functions.

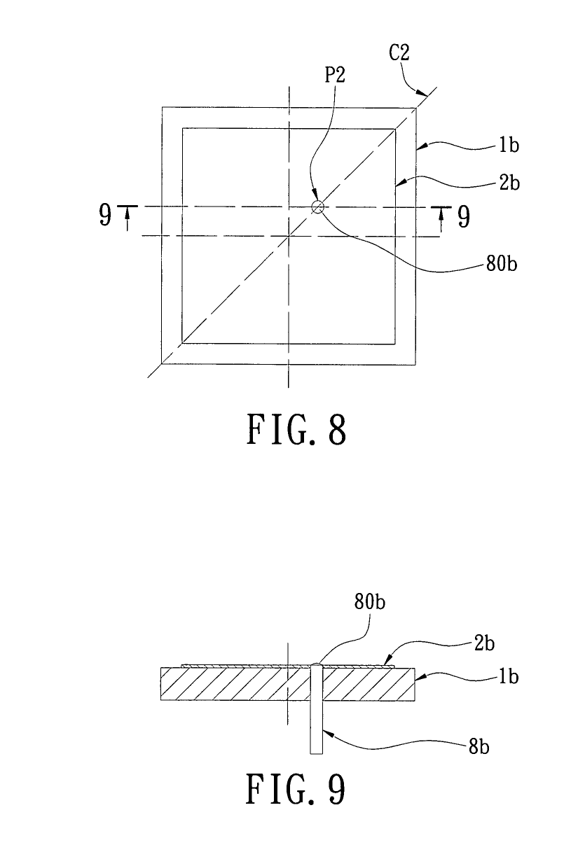

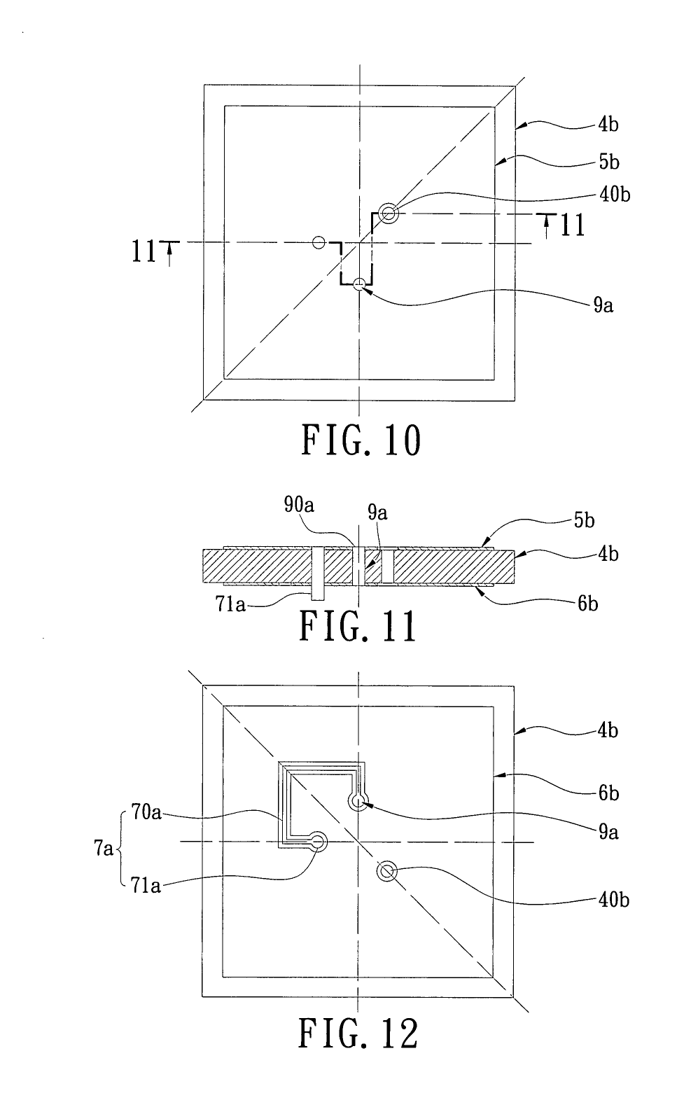

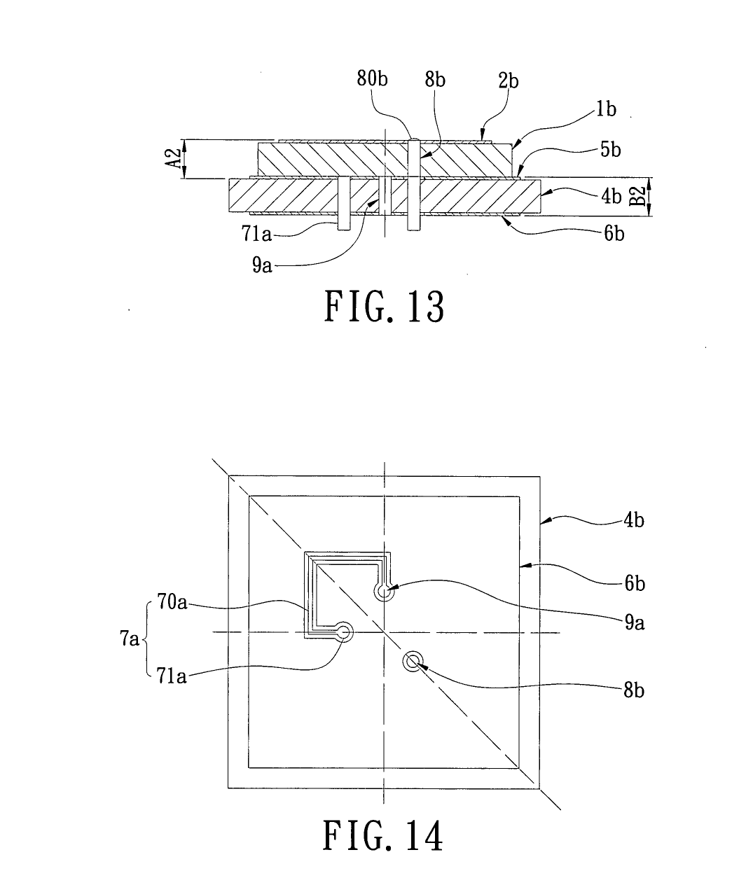

Referring to FIGS. 8 to 14, the second embodiment of the present invention provides a dual polarization antenna device for creating a band function. It means the present invention allows users to use dual polarization and dual band technologies. The device includes: a first dielectric body 1b, a patch layer 2b, a first phase difference changing structure 3a, a second dielectric body 4b, a common metal layer 5b, a ground layer 6b, a second phase difference changing structure 7a, a first antenna feed pin 8b, and a second antenna feed pin 9a

Referring to FIGS. 8 to 9 again, with regard to the first part of the second embodiment, the difference between the second embodiment and the first embodiment is that the first antenna feed pin 8b has a first feed point 80b exposed outside of the patch layer 2b. The first feed point 80b is disposed on a diagonal edge center line C2 of the patch layer 2b. A position P2 of the first feed point 80b is close to a center point of the diagonal edge center line C2 (as shown in FIG. 8) for generating 90 degree phase difference.

Referring to FIGS. 8 to 14 again, with regard to the second part of the second embodiment, the difference between the second embodiment and the first embodiment is that because the position of the first feed point 80b is changed, the position of a through hole 40b of the second dielectric body 4b is changed.

The first part and the second part share the common metal layer 5b. Hence, the first dielectric body 1b, the patch layer 2b, the common metal layer 5b, and the first antenna feed pin 8b are combined together to form an upper polarization antenna structure A2. The second dielectric body 4b, the common metal layer 5b, the second phase difference changing structure 7a, and the ground layer 6b are combined together to form a lower polarization antenna structure B2.

Therefore, the upper polarization antenna structure A2 and the lower polarization antenna structure B2 are combined to create both the dual polarization and the dual band functions.

According to the above-mentioned two embodiments, for the upper polarization antenna structure A1, the shape of the patch layer 2a and the position P1 of the first feed point 80a of the first antenna feed pin 8a are mated in order to create dual polarization and dual band functions. For the upper polarization antenna structure A2, the position P2 of the first feed point 80b of the first antenna feed pin 8b can create dual polarization and dual band functions directly.

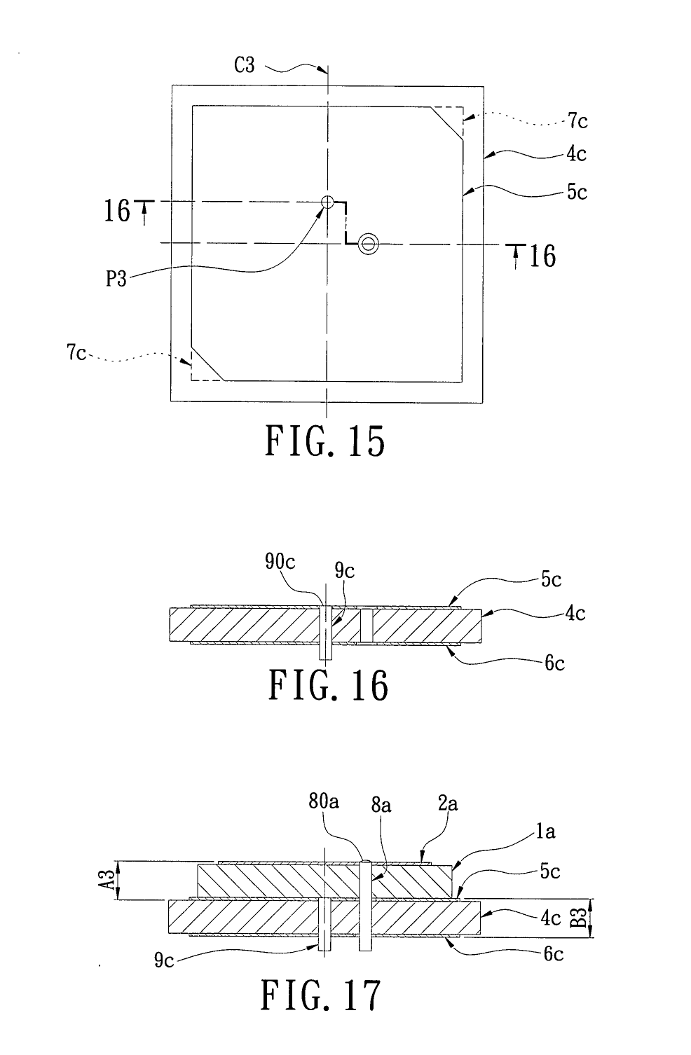

Referring to FIGS. 15 to 17, the second part of the third embodiment of the present invention includes: a second dielectric body 4c, a common metal layer 5c, a ground layer 6c, a second phase difference changing structure 7c, and a second antenna feed pin 9c. The second phase difference changing structure 7c is a pair of cutting areas that are formed on two diagonal edges of the common metal layer 5c. The pair of cutting areas is a pair of triangular areas of the same size. In other words, the common metal layer 5c has a square shape and is formed on the second dielectric body 4a. The pair of cutting areas on the two diagonal edges of the common metal layer 5c needs to be cut for generating 90 degree phase difference. In addition, the second antenna feed pin 9c extends from a bottom surface of the ground layer 6c. The second antenna feed pin 9c has a second feed point 90c exposed outside of the common metal layer 5c. The second feed point 90c is disposed on a two opposite sides center line C3 of the common metal layer 5c. A position P3 of the second feed point 90c is close to a center point of the two opposite sides center line C3 (as is shown in FIG. 15).

The first part of the first embodiment and the second part of the third embodiment are combined together. Therefore, the first dielectric body 1a, the patch layer 2a, the first phase difference changing structure 3a (as shown in FIG. 1), the common metal layer 5c, and the first antenna feed pin 8a are combined together to form an upper polarization antenna structure A3. The second dielectric body 4c, the common metal layer 5c, the second phase difference changing structure 7c, and the ground layer 9c are combined together to form a lower polarization antenna structure B3.

Therefore, the upper polarization antenna structure A3 and the lower polarization antenna structure B3 are combined to create both the dual polarization and the dual band functions.

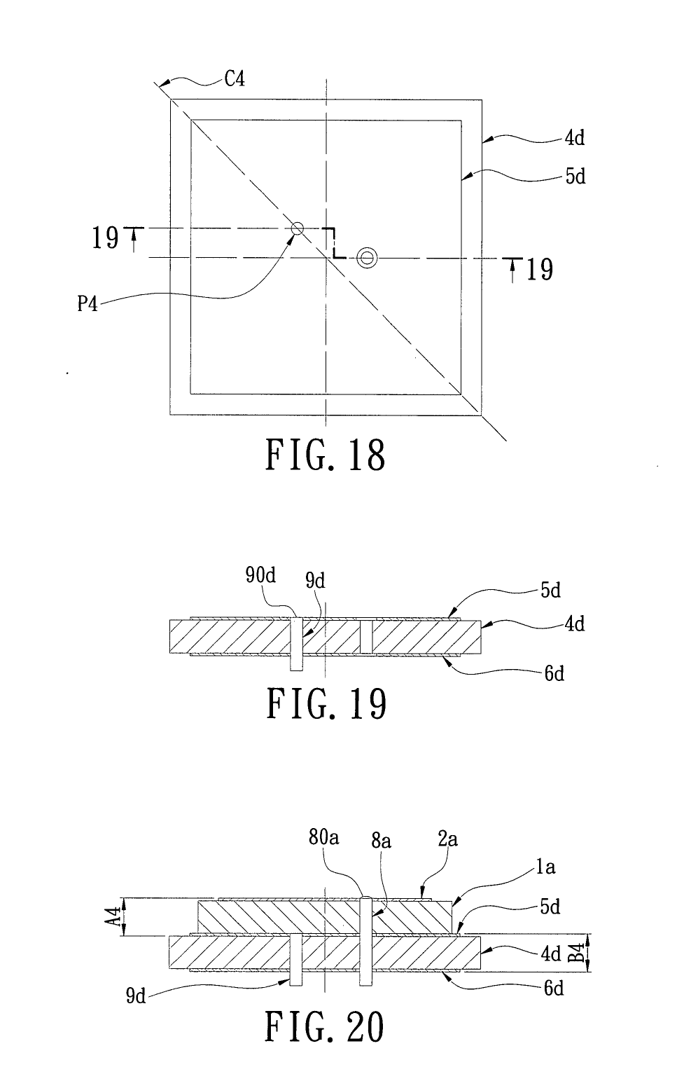

Referring to FIGS. 18 to 20, the second part of the fourth embodiment of the present invention includes: a second dielectric body 4d, a common metal layer 5d, a ground layer 6d, and a second antenna feed pin 9d. The second antenna feed pin 9d extends from a bottom surface of the ground layer 6d. The second antenna feed pin 9d has a second feed point 90d exposed outside of the common metal layer 5d. The second feed point 90d is disposed on a diagonal edge center line C4 of the common metal layer 5d. A position P4 of the second feed point 90d is close to a center point of the diagonal edge center line C4 as FIG. 18 for generating 90 degree phase difference.

The first part of the first embodiment and the second part of the fourth embodiment are combined together. Therefore, the first dielectric body 1a, the patch layer 2a, the first phase difference changing structure 3a (as shown in FIG. 1), the common metal layer 5d, and the first antenna feed pin 8a are combined together to form an upper polarization antenna structure A4. The second dielectric body 4d, the common metal layer 5d, and the ground layer 9d are combined together to form a lower polarization antenna structure B4.

Therefore, the upper polarization antenna structure A4 and the lower polarization antenna structure B4 are combined to create both the dual polarization and the dual band functions.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dual polarization antenna device for creating a dual band function, comprising:
a first dielectric body;
a patch layer formed on a top surface of the first dielectric body;
a first phase difference changing structure formed on the patch layer;
a second dielectric body;
a common metal layer formed between the first dielectric body and the second dielectric body;
a ground layer formed on a bottom surface of the second dielectric body;
a second phase difference changing structure formed in an inner portion and on the bottom surface of the second dielectric body;
a first antenna feed pin penetrating the first dielectric body and the second dielectric body in sequence; and
a second antenna feed pin penetrating the second dielectric body;
wherein the first dielectric body, the patch layer, the first phase difference changing structure, the common metal layer, and the first antenna feed pin are combined together to form an upper polarization antenna structure;
wherein the second dielectric body, the common metal layer, the second phase difference changing structure, and the ground layer are combined together to form a lower polarization antenna structure;
whereby, the upper polarization antenna structure and the lower polarization antenna structure are combined to create both the dual polarization and the dual band functions.

2. The dual polarization antenna device as claimed in claim 1, wherein the first dielectric body and the second dielectric body are made of a dielectric material.

3. The dual polarization antenna device as claimed in claim 2, wherein the dielectric material is a ceramic material or an insulative material.

4. The dual polarization antenna device as claimed in claim 1, wherein the first and the second phase difference changing structures are 90 degree phase difference changing structures.

5. The dual polarization antenna device as claimed in claim 1, wherein the first phase difference changing structure is a pair of cutting areas that are formed on two diagonal edges of the patch layer.

6. The dual polarization antenna device as claimed in claim 5, wherein the pair of cutting areas is a pair of triangular areas of the same size.

7. The dual polarization antenna device as claimed in claim 1, wherein the second phase difference changing structure includes a metal leading wire and an antenna pin, the metal leading wire is formed on a bottom surface of the second dielectric body and insulated from the ground layer, one side of the metal leading wire is electrically connected with a bottom side of the second antenna feed pin, and the other side of the metal leading wire is electrically connected with the antenna pin.

8. The dual polarization antenna device as claimed in claim 1, wherein a top side of the first antenna feed pin is exposed outside of the patch layer to form a first feed point, a bottom side of the first antenna feed pin extends from a bottom surface of the ground layer, and the first antenna feed pin is insulated from the common metal layer and the ground layer.

9. The dual polarization antenna device as claimed in claim 8, wherein the first feed point is disposed on a two opposite sides center line of the patch layer and is close to a center point of the two opposite sides center line.

10. The dual polarization antenna device as claimed in claim 1, wherein a top side of the second antenna feed pin is exposed outside of the common metal layer to form a second feed point, a bottom side of the second antenna feed pin is exposed outside of a bottom surface of the ground layer, and the second antenna feed pin is insulated from the ground layer.

11. A dual polarization antenna device for creating a dual band function, comprising:
a first dielectric body;
a patch layer formed on a top surface of the first dielectric body;
a second dielectric body;
a common metal layer formed between the first dielectric body and the second dielectric body;
a ground layer formed on a bottom surface of the second dielectric body;
a second phase difference changing structure formed in an inner portion and on the bottom surface of the second dielectric body;
a first antenna feed pin penetrating the first dielectric body and the second dielectric body in sequence; and
a second antenna feed pin penetrating the second dielectric body;
wherein the first dielectric body, the patch layer, the common metal layer, and the first antenna feed pin are combined together to form an upper polarization antenna structure;
wherein the second dielectric body, the common metal layer, the second phase difference changing structure, and the ground layer are combined together to form a lower polarization antenna structure;
whereby, the upper polarization antenna structure and the lower polarization antenna structure are combined to create both the dual polarization and the dual band functions.

12. The dual polarization antenna device as claimed in claim 11, wherein the first dielectric body and the second dielectric body are made of a dielectric material.

13. The dual polarization antenna device as claimed in claim 12, wherein the dielectric material is a ceramic material or an insulative material.

14. The dual polarization antenna device as claimed in claim 11, wherein the second phase difference changing structure is 90 degree phase difference changing structure.

15. The dual polarization antenna device as claimed in claim 11, wherein the second phase difference changing structure includes a metal leading wire and an antenna pin, the metal leading wire is formed on a bottom surface of the second dielectric body and insulated from the ground layer, one side of the metal leading wire is electrically connected with a bottom side of the second antenna feed pin, and the other side of the metal leading wire is electrically connected with the antenna pin.

16. The dual polarization antenna device as claimed in claim 11, wherein a top side of the first antenna feed pin is exposed outside of the patch layer to form a first feed point, a bottom side of the first antenna feed pin extends from a bottom surface of the ground layer, and the first antenna feed pin is insulated from the common metal layer and the ground layer.

17. The dual polarization antenna device as claimed in claim 16, wherein the first feed point is disposed on a diagonal edge center line of the patch layer and is close to a center point of the diagonal edge center line.

18. The dual polarization antenna device as claimed in claim 11, wherein a top side of the second antenna feed pin is exposed outside of the common metal layer to form a second feed point, a bottom side of the second antenna feed pin is exposed outside of a bottom surface of the ground layer, and the second antenna feed pin is insulated from the ground layer.

19. A dual polarization antenna device for creating a dual band function, comprising:
a first dielectric body;
a patch layer formed on a top surface of the first dielectric body;
a first phase difference changing structure formed on the patch layer;
a second dielectric body;
a common metal layer formed between the first dielectric body and the second dielectric body;
a ground layer formed on a bottom surface of the second dielectric body;
a second phase difference changing structure formed on the common metal layer;
a first antenna feed pin penetrating the first dielectric body and the second dielectric body in sequence; and
a second antenna feed pin penetrating the second dielectric body;
wherein the first dielectric body, the patch layer, the first phase difference changing structure, the common metal layer, and the first antenna feed pin are combined together to form an upper polarization antenna structure;
wherein the second dielectric body, the common metal layer, the second phase difference changing structure, and the ground layer are combined together to form a lower polarization antenna structure;
whereby, the upper polarization antenna structure and the lower polarization antenna structure are combined to create both the dual polarization and the dual band functions.

20. The dual polarization antenna device as claimed in claim 19, wherein the first dielectric body and the second dielectric body are made of a dielectric material.

21. The dual polarization antenna device as claimed in claim 20, wherein the dielectric material is a ceramic material or an insulative material.

22. The dual polarization antenna device as claimed in claim 19, wherein the first and the second phase difference changing structures are 90 degree phase difference changing structures.

23. The dual polarization antenna device as claimed in claim 19, wherein the first and the second phase difference changing structures are a pair of cutting areas that are formed on two diagonal edges of the patch layer.

24. The dual polarization antenna device as claimed in claim 19, wherein the pair of cutting areas is a pair of triangular areas of the same size.

25. The dual polarization antenna device as claimed in claim 19, wherein a top side of the first antenna feed pin is exposed outside of the patch layer to form a first feed point, a bottom side of the first antenna feed pin extends from a bottom surface of the ground layer, and the first antenna feed pin is insulated from the common metal layer and the ground layer.

26. The dual polarization antenna device as claimed in claim 25, wherein the first feed point is disposed on a two opposite sides center line of the patch layer and is close to a center point of the two opposite sides center line.

27. The dual polarization antenna device as claimed in claim 19, wherein a top side of the second antenna feed pin is exposed outside of the common metal layer to form a second feed point, a bottom side of the second antenna feed pin extends from a bottom surface of the ground layer, and the second antenna feed pin is insulated from the ground layer.

28. The dual polarization antenna device as claimed in claim 27, wherein the second feed point is disposed on a two opposite sides center line of the common metal layer and is close to a center point of the two opposite sides center line.

29. A dual polarization antenna device for creating a dual band function, comprising:
a first dielectric body;
a patch layer formed on a top surface of the first dielectric body;
a second dielectric body;
a common metal layer formed between the first dielectric body and the second dielectric body;
a ground layer formed on a bottom surface of the second dielectric body;
a first antenna feed pin penetrating the first dielectric body and the second dielectric body in sequence; and
a second antenna feed pin penetrating the second dielectric body;
wherein the first dielectric body, the patch layer, the common metal layer, and the first antenna feed pin are combined together to form an upper polarization antenna structure;
wherein the second dielectric body, the common metal layer, the ground layer, and the second antenna feed pin are combined together to form a lower polarization antenna structure;
whereby, the upper polarization antenna structure and the lower polarization antenna structure are combined to create both the dual polarization and the dual band functions.

30. The dual polarization antenna device as claimed in claim 29, wherein the first dielectric body and the second dielectric body are made of a dielectric material.

31. The dual polarization antenna device as claimed in claim 30, wherein the dielectric material is a ceramic material or an insulative material.

32. The dual polarization antenna device as claimed in claim 29, wherein a top side of the first antenna feed pin is exposed outside of the patch layer to form a first feed point, a bottom side of the first antenna feed pin extends from a bottom surface of the ground layer, and the first antenna feed pin is insulated from the common metal layer and the ground layer.

33. The dual polarization antenna device as claimed in claim 32, wherein the first feed point is disposed on a diagonal edge center line of the patch layer and close to a center point of the diagonal edge center line.

34. The dual polarization antenna device as claimed in claim 29, wherein a top side of the second antenna feed pin is exposed outside of the common metal layer to form a second feed point, a bottom side of the second antenna feed pin extends from a bottom surface of the ground layer, and the second antenna feed pin is insulated from the ground layer.

35. The dual polarization antenna device as claimed in claim 34, wherein the second feed point is disposed on a diagonal edge center line of the common metal layer and close to a center point of the diagonal edge center line.
